(19) United States
(12) Patent Application Publication
(10) Pub. No.: US 2012/0217722 A1
(43) Pub. Date: Aug. 30, 2012

(54) MOLD AND PROCESS FOR OBTAINING A BICYCLE FRAME MADE OF RECYCLABLE POLYMER

(76) Inventor: Juan Carlos Calabresse Muzzi, Sao Paulo (BR)

(21) Appl. No.: 13/362,120

(22) Filed: Jan. 31, 2012

(30) Foreign Application Priority Data
Jan. 31, 2011 (BR) PI1100578-5

(51) Int. Cl. B29C 45/33; B62K 3/02

(52) U.S. Cl. 280/281.1; 264/328.1; 425/577

(57) ABSTRACT

A mold and an injection process for making a one-piece bicycle frame made of recyclable polymer. The mold includes one stationary part and one movable part. Sliding columns with guiding lower portions are formed in the stationery part. Both the stationary part and movable part are provided with base plates for supporting bearing cavity plates that collectively form a structural channel that receives a thermal injected polymer. The cavity bearing plate of the movable part includes a longitudinal bed that receives a main central drawer and side beds that receive secondary drawers. The longitudinal bed includes peripheral tracks enabling the main drawer to slide. The bed includes drawing pins positioned at an angle, allowing the main drawer to move horizontally. The side beds also include drawing pins for the secondary drawers.

### CROSS-REFERENCE TO RELATED APPLICATIONS

This application claims priority to Brazilian Patent Application PI1100578-5 filed on Jan. 31, 2011, the entire contents of which are herein incorporated by reference.

### BACKGROUND OF THE INVENTION

1. Field of the Invention

This invention relates to a mold and process for obtaining a bicycle frame made of recyclable polymer and, more particularly, it relates to an injection mold of a type having a drawer for an injection process specially designed for the manufacture of a single piece bicycle frame made with polymeric material that is particularly originated from recycled and re-used polyethylene terephthalate (PET) bottles; such bicycle frame made into a design having resistant and flexible mechanical features.

2. Brief Description of the Related Art

It is widely known that the manufacture of products made of polymers has increased very fast since polymer-made products remarkably offer a good mechanical resistance, flexibility, lightness, long durability in addition to offer an option for variation in the colors used, shapes, dimensions and other particulars.

The possibility of having a plastic re-used by recycling is a basic feature to use a polymer for the manufacture of several products, notably the recycling of PET bottles that allows the manufacture of numerous products such as undershirts, solar panels, brooms and so on; further, this considerably helps in the preservation of the environment and all the chain linked to the environment by reducing a considerable volume of garbage disposed into garbage dumps and by providing an improvement in the process of decomposition of organic matters, by achieving considerable savings in the use of petroleum, considerable savings in the use of electrical energy for the production of a new plastic and as well by making possible to create new jobs for people in the area of recycled materials and mainly by reducing the cost of products based on recycled materials.

A few conventional methods are available for the manufacture of products based on polymers such as injection process; however, it is indispensable for a good molding process to follow some criteria, notably the mold design and the steps of the injection process and as well the mechanisms working with the mold, the site in which the injection will be done, the way of pushing out the manufactured product from the mold, the system used to assemble the product, the engraving conditions and other processing features so as to avoid additional working operations and to ensure mechanical, physical and aesthetic functions of the resulting product.

In a general aspect the molds used today for injection process are made into at least two parts. One of said parts is placed on a stationary plate and the other part is placed on a moving plate. Both parts are interconnected by columns and guiding bushes that guide the moving part so as to be jointed to the stationary part.

The alignment of both halves is crucial since it prevents any kind of plastic leakage when plastic is injected under a high pressure into the cavity whilst feeding channels are points planned between the injection channel and the cavity.

Another factor extremely crucial in the mold for plastic injection is related to how injection points are placed and provided. Injection points are also known as gate points and correspond to a point invaded by melted materials in the cavities of the mold since the cavities have a role of allowing the melted materials to flow through. Several ways of inputting materials are used such as those known as gate with restricted rectangular entry and yet an input entry shaped either as a fan or as a rim, as a restricted entry and others. Each type of injection point, e.g., a gate, is correspondent with the type of product that will be pushed out from the mold and therefore such type of end product has to do with the design of said mold.

Another crucial feature of the injection point is related to its dimension since some care must be necessarily taken with respect to the rate of and applied tension of shear force which should be the lowest possible without, however, provoking molecules or fibers to break.

The site the injection point, or also known as gate, is located is one place seldom used or never seen and the closest possible to the centre of the mold and a part of the mold which is provided with its thicker area; that is meant to say that areas that suffer intense tension or are mechanically often used should be avoided.

However, a few detailed complex molds are designed with two or more injection points which will make it unable to follow the aforesaid criteria mainly those molds that require the use of a drawer since the motion of the drawer will provoke intense friction action and tension in the injection point and a consequent degradation of materials.

This patent applicant has been working in the area of development of thermally molded plastic products and had filed a previous patent application related to a single-piece bicycle frame for which conventional parts that make up a bicycle, such as the saddle supporting tube, the front wheel fitting fork, the main sprocket wheel, the rear wheel and the secondary sprocket wheel were specially designed. The single-piece bicycle frame of the previous patent application is integrally molded with a virgin or recycled rigid polymer and manufactured into a single piece and made of a central bar whereof identical side arms are provided. Such single-piece bicycle frame may be made with an adequate pigment color, opaque or translucent. In spite of the developments provided in such single-piece frame some difficulties remained in relation with the injection process and therefore adjustments would be required as it concerns to design.

### BRIEF SUMMARY OF THE INVENTION

Further considering the improvement of the previous bicycle frame molding process and yet considering the use of recyclable materials in the composition of the injected plastic materials this patent applicant developed a mold with its corresponding process for obtaining a recyclable polymer bicycle frame and, more specifically, an injection mold of the type provided with a drawer used in the injection process and specially designed to manufacture a single piece bicycle frame made with polymeric material specifically originated from recycled and re-used PET made bottles. Said single bicycle frame is made with design configurations provided with resistant and flexible mechanical features. The object claimed in this instant claimed invention aids in the preservation of the environment since recyclable materials are employed.

The main advantage of the instant claimed invention is found in that the new functional design of the mold prevents failures to occur during the production process of said bicycle frame thus also preventing the existence of worn-out parts, grippings or broken parts.

Another relevant feature of the instant claimed invention is found in that the mold allows a versatile removal of bolts, screws and drawing pins in a way to make maintenance easier and as a consequence also making easier the serial production of the single piece bicycle frame. Further, this ensures production safety for the worker.

Another advantage is found in that at least two hundred PET bottles are used for the production of said recyclable polymer bicycle frame and this significanty offers a contribution for preservation of the environment. Further, it means an extremely reduced production cost when compared to the bicycle frames currently used.

### BRIEF DESCRIPTION OF THE DRAWINGS

In order to complement the patent application specification so as to obtain a better understanding of the features of this invention and in accordance with a preferred embodiment of the invention a set of drawings goes together whereof in an exemplified manner the working details are taught without, however, meant to limit the scope of the invention.

FIG. 1 is a perspective exploded view of the mold now innovated.

FIG. 2 illustrates a perspective view of an assembled mold.

FIG. 3 illustrates a longitudinal section view.

FIG. 4 illustrates a cross section view.

FIGS. 5 and 6 illustrate side views of cavities bearing plates.

FIG. 7 illustrates a side view of cavities bearing plate in which the main drawer and the secondary drawers are illustrated in an exploded view.

FIG. 8 illustrates a block diagram of the process for obtaining the bicycle frame, and

FIG. 9 illustrates a perspective view of the resulting bicycle frame

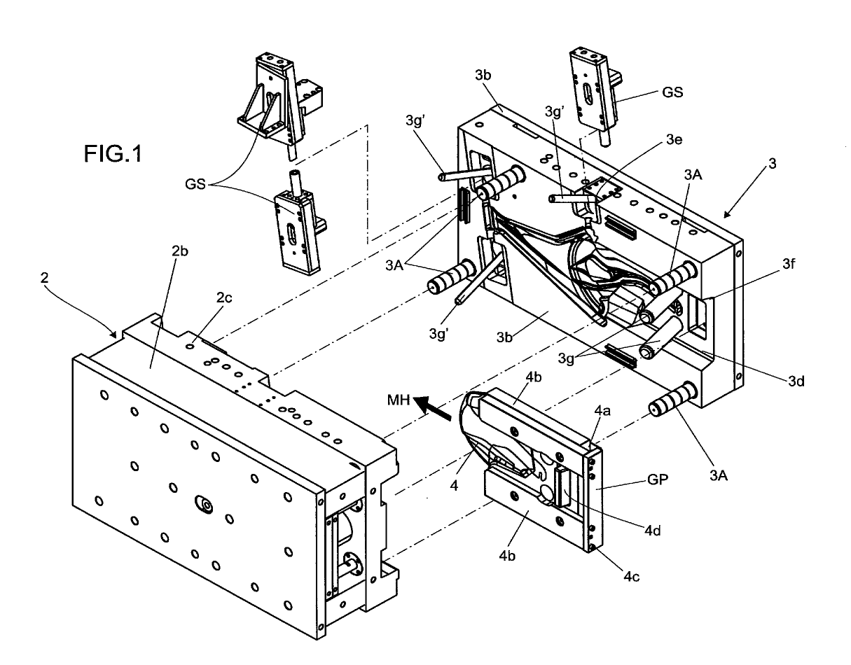

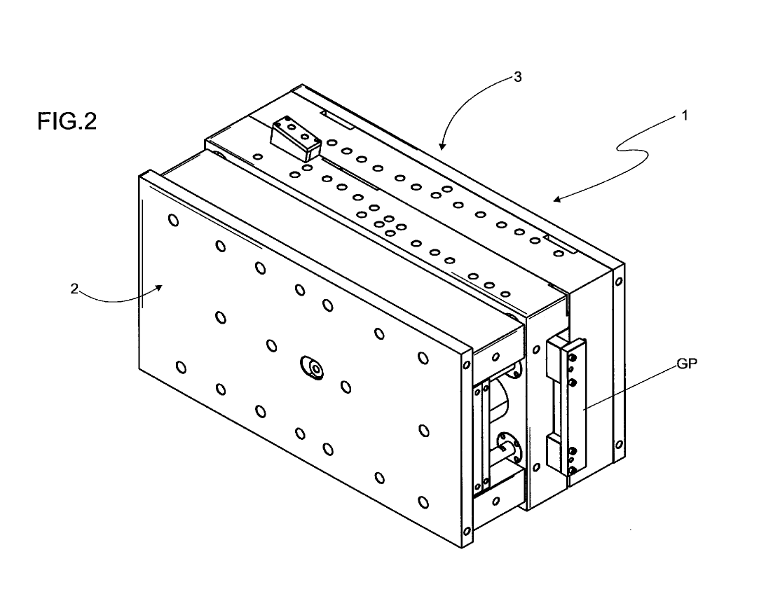

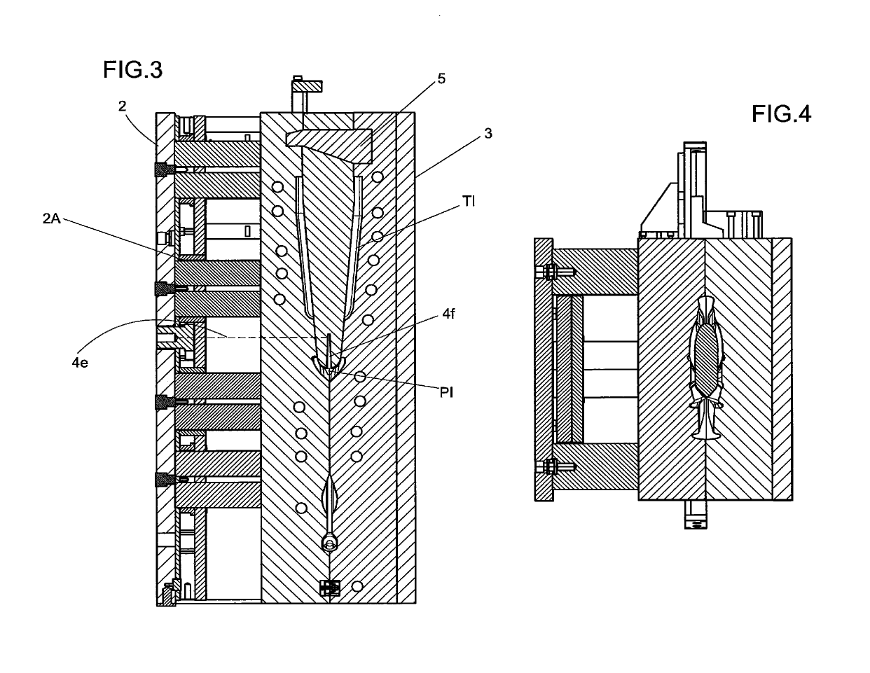

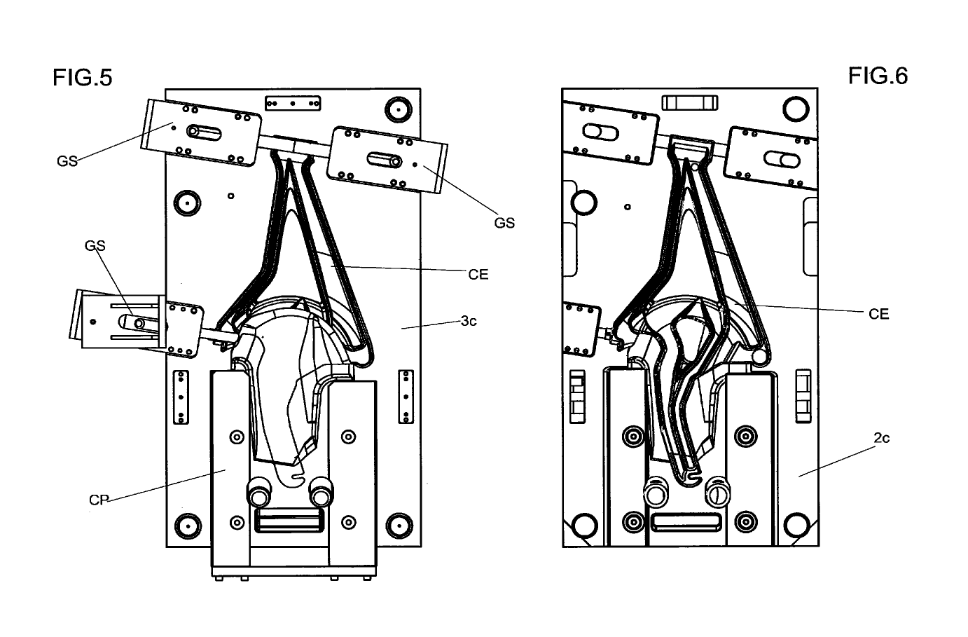

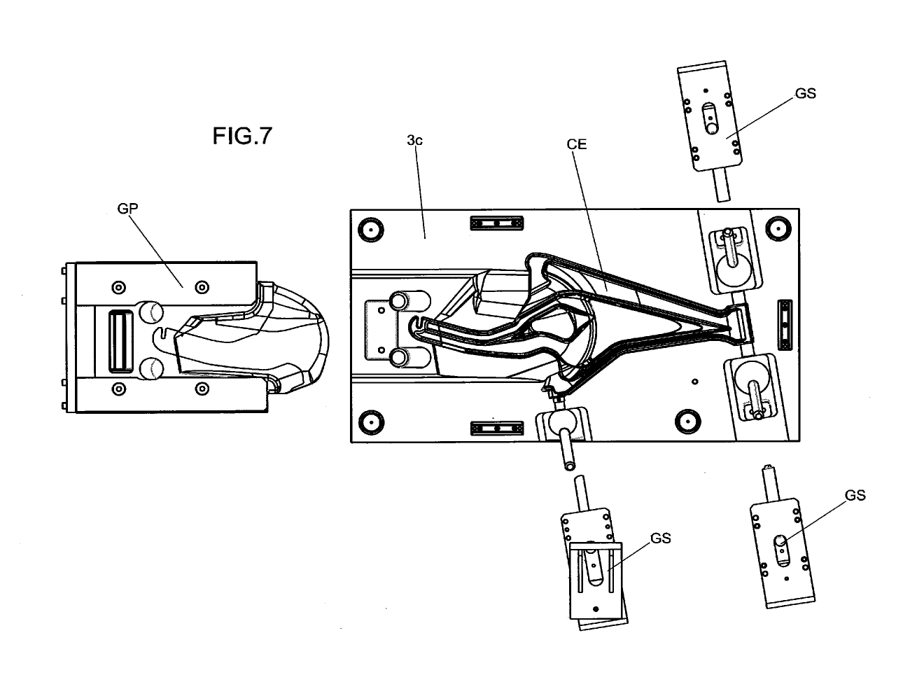

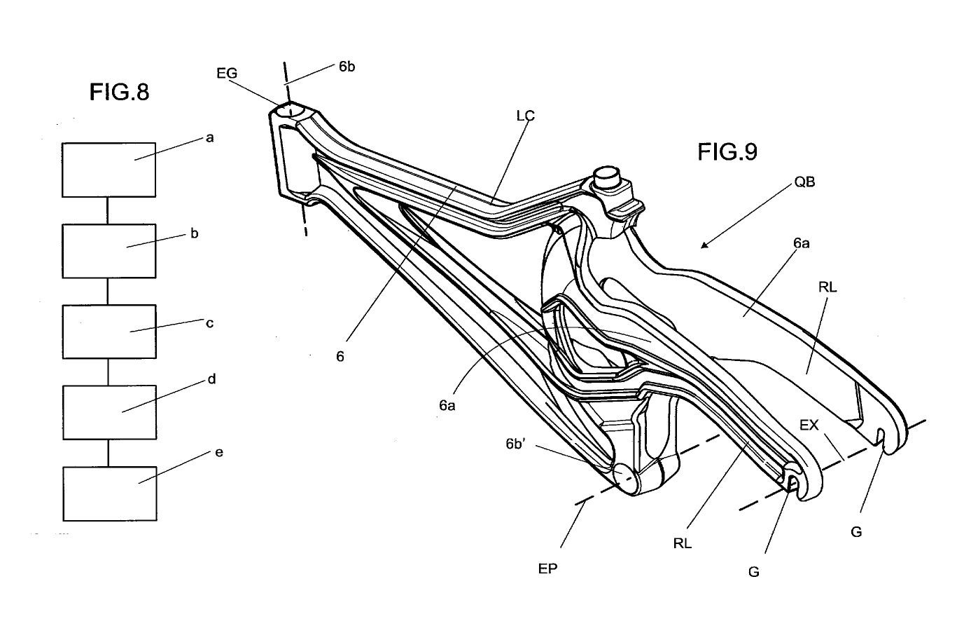

### DETAILED DESCRIPTION OF THE PREFERRED EMBODIMENT

With reference to the accompanying drawings this instant claimed invention relates to a mold and a process for obtaining a bicycle frame made of recyclable polymer, more specifically it teaches a mold (1) and a process (PO) for obtaining said mold whereof a polymeric and single-piece bicycle frame (QB) is obtained with mechanical resistant and flexible features.

In accordance with this instant claimed invention said mold (1) is made of two complementary parts. One stationary part (2) and one movable part (3) which are provided with sliding columns (3A) with guiding lower portions (2A) provided in the stationary part (2). Both stationary part (2) and movable part (3) are provided with base plates (2b) and (3b) to assemble respective cavity bearing plates (2c) and (3c) which make up a structural channel (CE) whereof the injected thermal polymer (TI) is received and the bicycle frame (QB) is obtained subsequently.

The cavity bearing plate (3c) of the movable part (3) is provided with a longitudinal bed (3d) whereof the main central drawer (GP) is assembled and yet said cavity bearing plate is provided with side beds (3e) whereof the secondary drawers (GS) are assembled. Said longitudinal bed (3d) is provided with peripheral tracks (3f) whereof the main drawer (GP) slides through and further said longitudinal bed is provided with drawing pins (3g) which standing angle allows the main drawer (GP) to move on horizontally (MH) whilst side beds (3e) are also provided with drawing pins (3g′) for secondary drawers (GS).

Said main drawer is provided with an oblong configuration (4) which side edges (4a) are surrounded by straight frames (4b) whilst a slight cut entry is provided close to the bottom edge (4c) so as to couple a locking wedge (5) provided in the cavity bearing plate (2c) of the stationary part. Said main drawer (GP) is also provided with a receiving channel (4e) to receive the injected thermal polymer (TI) and an outlet flowing channel (4f) to distribute the injected thermal polymer (TI) and subsequently to form a unique injection point (PI) on said structural channel (CE) which configuration into an “Y” makes up a central bar (LC) whereof identical side arms (RL) are originated in order to obtain a single-piece bicycle frame (QB).

The central part located amongst the arms (RL) of upper and lower cavities is aligned in relation with said central drawer (GP) whilst in the vertices of structural channel (CE) said secondary drawers (GS) are assembled in.

The process (PO) for obtaining the recyclable polymer bicycle frame (QB) is comprised of the following steps:

a) Reception of the recycled materials such as PET bottles;

b) Grinding the bottles so as to become a powder;

c) Processing the powder into polymeric granules mixed with additives so as to impart protection against bad weather conditions;

d) Injection of a thermal plastic into the innovated mold;

e) Obtaining a bicycle frame.

The product that results from the obtaining process (PO) is a bicycle frame (QB) made as one-piece frame in a shape that is usually in the form of a “Y” and making up a central bar (6) whereof identical side arms (6a) are originated having two tubular vertices (6b). One of tubular vertices stands horizontally (6b′) and is meant to have the sprocket wheel axle (EP) assembled thereof; the other tubular vertices stands vertically (6b″) and is meant to have handlebar axle (EG) assembled thereof

The end portions of each arm are provided with the shape of a hook (G) whereof an axle meant to engage the rear wheel (not shown) is assembled.

It is certain that when this instant claimed invention is put into practise modifications might be made as to some design and form details, however, without departing from the basic principles clearly supported by the full set of claims. Thus it is to be understood that the terminology herein employed was not meant to any limit of the invention.

What is claimed is:

1. A mold and an injection process for obtaining a bicycle frame made of recyclable polymer, more specifically, it is related to a mold (1) and a process (PO) I whereof a polymeric and single-piece bicycle frame (QB) is obtained with resistant and flexible mechanical features; characterized in that the mold (1) is made of two complementary parts, namely: one stationary part (2) and one movable part (3) which is provided with sliding columns (3A) with guiding lower portions (2A) provided in the stationary part (2); both stationary part (2) and movable part (3) are provided with base plates (2b) and (3b) meant to have respective cavity bearing plates (2c) and (3c) assembled thereof thus jointly forming a structural channel (CE) meant to receive an injected thermal polymer (TI) and thus obtaining a bicycle frame (QB) subsequently; a longitudinal bed (3d) is provided in the cavity bearing plate of the movable part (3) meant to have the main central drawer (OP) assembled thereof and side beds (3e) meant to have the; secondary drawers (OS) assembled thereof. Said longitudinal bed (3d) is provided with peripheral tracks (3t) so that the main drawer (OP) slides therethrough and further is provided with drawing pins (3g) positioned in an angle that allows the main drawer (OP) to move on horizontally (MH). The side beds (3e) are also provided with drawing pins (3g′) for the secondary drawers (OS).

2. A mold and an injection process for obtaining a bicycle frame made of:
recyclable polymer in accordance with the previous claim, characterized in that the main drawer (OP) is made up of an oblong piece (4) which side edges (4a) are surrounded by straight frame strips (4b) whilst the bottom lower edge is provided with a cut (4d) to engage a wedge (5) provided in the cavity bearing plate (2c) of the stationary part (2); further, the main drawer (OP) is provided with a receiving channel (4e) so as to receive ˜n injected thermal polymer (TI) and also provided with an outlet flowing channel (4t) to distribute an injected polymer (TI) and subsequently to develop an unique injection point (PI) in said structural channel (CE) which shape into a “Y” makes up a central bar (LC) whereof identical side arms (RL) are originated so as to obtain a one-piece bicycle frame (QB); a central portion amongst arms (RL) in the upper and lower cavities is aligned with said central drawer (OP) whilst said secondary drawers (OS) are; assembled in the vertices of structural channel (CE).

3. An injection process for obtaining a bicycle frame in accordance with claim 1, characterized in that said process for obtaining (PO) a recyclable polymer bi6Ycle frame a) Reception of the recycled materials such as PET bottles;
b) Grinding the bottles so as to become powder;
c) Processing the powder into polymeric granules mixed with additives so as to impart protection against bad weather conditions;
d) Injection of a thermal plastic into the innovated mold;
e) Obtaining a bicycle frame.

4. A recyclable polymer bicycle frame in accordance with the previous claims characterized in that the bicycle frame is usually “Y” shaped and formed 9f a single piece thus making up a central bar (6) whereof identical side arms (6a) are originated and form two tubular vertices (6b); one tubular horizontal vertex (6b′) !whereof a sprocket wheel axle (EP) is assembled in and other tubular vertex axle whereof the handlebar axle (EG) is assembled in; end edges of each arm is provided with a hook shape (G) whereof a rear wheel supporting axle (EX) is engaged in.
